(19) United States
(12) Patent Application Publication
(10) Pub. No.: US 2026/0161771 A1
(43) Pub. Date: Jun. 11, 2026

(54) Automated Evaluation, Scoring, and Quarantine of Third-Party Patches for Application Software

(71) Applicant: Automox Inc., Boulder, CO (US)

(72) Inventors: Cody Dietz, Fort Wayne, IN (US); Ryan Braunstein, Orlando, FL (US); Mathew Lee, Broomfield, CO (US)

(21) Appl. No.: 18/974,139

(22) Filed: Dec. 9, 2024

(51) Int. Cl. G06F 21/53; G06N 5/01

(52) U.S. Cl. CPC G06F 21/53; G06N 5/01; G06F 2221/033

(57) ABSTRACT

A technique is directed to methods and systems for evaluating patches for third-party applications for information technology or security-safety before installation. The patch evaluation system determines if a software patch is safe before making the patch available for installation. If the patch evaluation system determines a patch is unsafe, the patch is quarantined, placed in a queue for manual review, and/or is designated as not available for installation. For example, the system evaluates every patch for known malware before making that patch available to users for installation.

### BACKGROUND

Software patches may be unsafe from an information technology (IT) or security perspective. From an IT perspective, software patches can have high failure rates that can slow or damage a system. From a security perspective, software patches can contain malicious code which can infect a system and cause significant damage. Users want to ensure, before installation on their device or network, that a software patch is determined “safe” and does not include any known malware.

### BRIEF DESCRIPTION OF THE DRAWINGS

FIG. 1 is a flow diagram illustrating a process used in some implementations for calculating a patch safe score, in accordance with one or more embodiments of the present technology.

FIG. 2 is a flow diagram illustrating a process used in some implementations for approving an installation of a patch, in accordance with one or more embodiments of the present technology.

FIG. 3 is a flow diagram illustrating a process used in some implementations for calculating a successful installation rate of a patch, in accordance with one or more embodiments of the present technology.

FIG. 4 illustrates an example diagram for evaluating a patch, in accordance with one or more embodiments of the present technology.

FIG. 5 illustrates an example diagram for calculating a patch safe score, in accordance with one or more embodiments of the present technology.

FIG. 6 is a block diagram illustrating an overview of devices on which some implementations can operate.

FIG. 7 is a block diagram illustrating an overview of an environment in which some implementations can operate.

FIG. 8 is a block diagram illustrating components which in some implementations can be used in a system employing the disclosed technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for evaluating patches for third-party applications for information technology (IT) or security-safety before installation. With the increasing prevalence of software supply-chain attacks and the disruption from patch installation failures, users need assurance that the patches they are applying to third party applications on their devices do not introduce vulnerabilities or impair device performance. The patch evaluation system provides an automated evaluation of patches for third party software for IT or security safety prior to installation or application of the patches.

The patch evaluation system determines if a software patch is safe (e.g., by IT or security standards) before making the patch available for installation. If the patch evaluation system determines a patch is unsafe (e.g., contains malware), the patch is quarantined, placed in a queue for manual review, and/or is designated as not available for installation. For example, the system evaluates every patch for known malware before making that patch available to users for installation.

The patch evaluation system can evaluate patches against heuristics for IT or security safety. The heuristics can include code cave analysis, detlab analysis, packer detection, return-oriented programming (ROP) gadget mapping, and/or code snippet similarity scoring. The results of the heuristic evaluations are used to create one or more patch safe scores. Users can designate a threshold(s) for individual heuristics or scores, such that patches do not appear as available for a user to install unless the patch passes the user threshold(s). When a patch does not pass the user set threshold, the patch can undergo a manual review/approval before installation in a system or network. An example of a user set threshold is a patch installation success rate. The patch evaluation system collects data on the failure/success of each patch installation. The patch evaluation system calculates the successful installation rate for individual patches. In some embodiments, the successful installation rate is based on characteristics of the environment in which the patch is installed. A user can set the thresholds as a pre-determined “successful installation percentage”, that has to be met before installation of a patch is approved. The threshold(s) can be combined with other data. In a first example, a user sets a lower successful installation threshold if a patch is remediating a “critical” vulnerability. In a second example, a user sets a higher successful installation threshold if a patch is remediating a “medium” vulnerability.

As described in detail below, implementations of the present technology can provide technical advantages over conventional technology. In a first example, the patch evaluation ensures that third party software is free of malicious software. In a second example, the patch evaluation allows users to evaluate patches based on other heuristics, such as patch failure rate, and install (or not) based on user specific settings/requirements. In a third example, the patch evaluation increases system security by quarantining flagged software (e.g., malware) for manual detection/validation prior to installation. In a fourth example, the patch evaluation system utilizes several heuristics to tailor the availability or presentation of patches to individual user requirements.

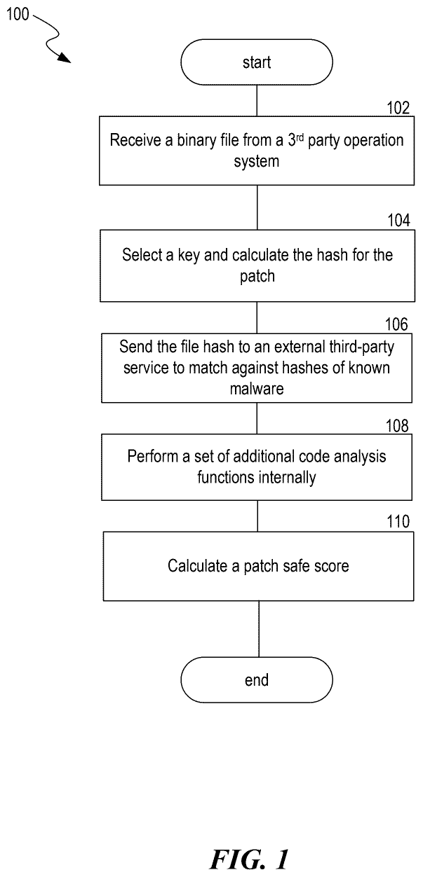

Several implementations are discussed below in more detail in reference to the figures. FIG. 1 is a flow diagram illustrating a process used in some implementations for calculating a patch safe score, in accordance with one or more embodiments of the present technology. In some implementations, process 100 is triggered by a user activating a patch evaluation application, powering on a device, the user accessing a patch provider database via a website portal, a machine or device receiving a patch from a manufacturer, or the user downloading an application on a device to access the patch evaluation system. In various implementations, some or all of process 100 is performed locally on the user device or performed by cloud-based device(s) that can provide/support the patch evaluation system.

At step 102, the patch evaluation system receives a binary file from a third-party operating system, or an application deposits the binary file into a storage system. The patch evaluation system identifies a patch within the binary file for installation on a device or network. The patch evaluation system can store the patch in a temporary queue for evaluation.

At step 104, the patch evaluation system selects a key (e.g., an S3 key) for the patch and calculates the hash for the patch. The patch evaluation system may calculate the hash for a patch using a cryptographic hash function. The system may employ various hash algorithms, such as SHA-256 (Secure Hash Algorithm 256-bit), which produces a fixed-size 256-bit (32-byte) hash value. This hash value can serve as a unique identifier for the patch, allowing for efficient comparison and verification processes. The hash calculation may involve processing the entire binary content of the patch file, ensuring that even minor changes to the patch would result in a significantly different hash value.

The patch evaluation system can use the calculated hash in multiple stages of the patch evaluation process. For example, the system compares the calculated hash against a database of known safe or malicious hashes to quickly identify previously analyzed patches. Additionally, the hash may be sent to external third-party services for further analysis or verification. In some cases, the patch evaluation system may calculate and store multiple hashes using different algorithms to provide redundancy and compatibility with various security tools and databases. The key and calculated hash are placed in a queue for analysis.

At step 106, the patch evaluation system executes a heuristic function (e.g., a scanning heuristics lambda) to select and send the file hash to an external third-party service. The external third-party service can compare the file hash against hashes of known malware. For example, the external third-party service analyzes suspicious files and URLs to detect types of malware and malicious content using antivirus engines and website scanners. In some implementations, executing a heuristic function includes applying a set of predefined rules or algorithms to analyze the patch for potential security risks or performance issues. The heuristic function may examine various aspects of the patch, such as its code structure, file size, and behavior patterns. This analysis can identify suspicious characteristics that could indicate the presence of malware or other security threats. The heuristic function can assess the patch's compatibility with the target system and estimate its potential impact on system performance.

The results of the heuristic function execution may be used to generate a preliminary safety assessment of the patch. This assessment may include a numerical score or a set of flags indicating potential areas of concern. In some cases, the heuristic function may employ machine learning techniques to improve its accuracy over time, learning from previously analyzed patches and their outcomes. The output of the heuristic function may be combined with other evaluation methods, such as the external third-party service analysis, to provide a comprehensive assessment of the patch's safety and suitability for installation.

At step 108, the patch evaluation system performs additional code analysis heuristic functions internally on the patch to detect error or malware in the patch. For example, the patch evaluation system conducts a code cave analysis, a detlab analysis, a packer detection, ROP gadget mapping, and/or a code snippet similarity scoring.

At step 110, the patch evaluation system calculates a patch safe score based on the results of the additional code analysis and/or the results of the third-party service analysis. For example, factors of the additional code analysis (i.e. code cave analysis) can yield a score (e.g., 0-100%) or a binary pass/fail (i.e. detlab analysis). Each factor result in the additional code analysis can be weighted either based on predetermined benchmarks or a customer's security prioritizations. For example, the weight for code cave analysis is 20%, detlab analysis is 10%, packer detection is 50%, ROP gadget mapping is 10%, and a code snippet similarity scoring is 10%. The system can combine these weighted scores to produce a final patch safe score, which may be expressed as a percentage or a numerical value within a predefined range.

The patch safe score calculation process may also incorporate machine learning techniques to dynamically adjust the weights and scoring algorithms based on historical data and evolving security trends. In some cases, the system may use different scoring models for various types of patches or software applications, recognizing that different categories of software may have distinct security considerations. Additionally, the patch evaluation system may allow users or administrators to customize the scoring algorithm by adjusting weights or incorporating additional factors specific to their organization's security policies and risk tolerance levels. This flexibility in calculating the patch safe score may enable organizations to tailor the evaluation process to their unique security requirements and operational environments.

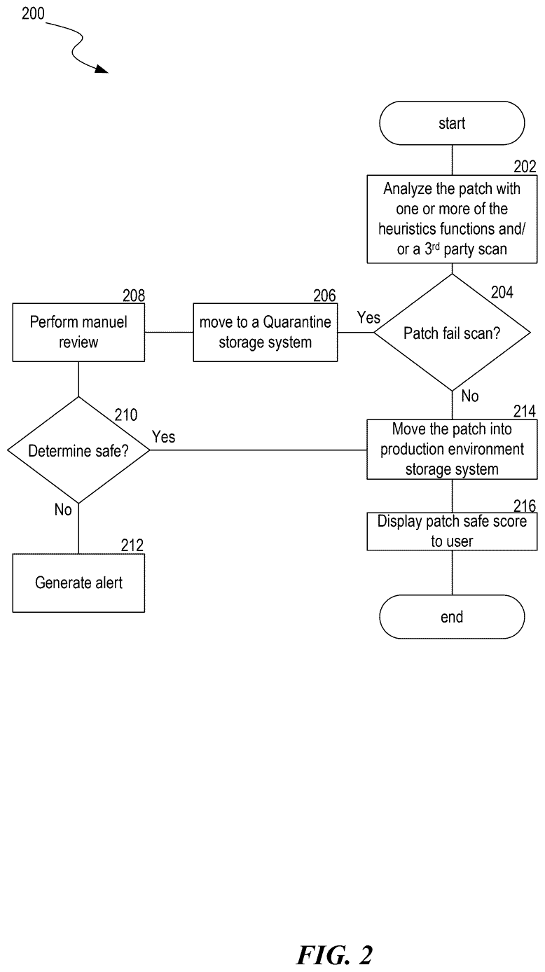

FIG. 2 is a flow diagram illustrating a process used in some implementations for approving an installation of a patch, in accordance with one or more embodiments of the present technology. In some implementations, process 200 is triggered by a user activating a patch evaluation application, powering on a device, the user accessing a patch provider database via a website portal, a machine or device receiving a patch from a manufacturer, or the user downloading an application on a device to access the patch evaluation system. In various implementations, some or all of process 200 is performed locally on the user device or performed by cloud-based device(s) that can provide/support the patch evaluation system.

At step 202, the patch evaluation system analyses the patch with a heuristic function(s) and/or the external third-party service (as described in steps 106 and 108 of FIG. 1).

At step 204, the patch evaluation system determines if the patch fails the heuristics function(s) or the external third-party service. In a first example, the patch fails the heuristic function(s) or the external third-party service based on the patch containing known malware. In a second example, the patch fails the heuristic function(s) or the external third-party service based on the patch safe score being below a threshold. The patch evaluation system can run a patch through different virus scans. In a first example, if a patch fails a virus scan by an established/approved virus scan provider, the patch fails the heuristic. In a second example, if a patch fails a threshold number of virus scans by non-approved scan providers, the patch fails the heuristic. A patch failing a virus scan can be a weighted factor to result in a heuristics score. A user can determine and set what heuristics score would pass/fail based on priorities or assigned weights. The priorities and weights can be further modified by basing a pass/fail score on the aggregate heuristics score or a component of the same. For example, a customer has to option to choose to have a patch fail if either (a) the composite score was less than threshold value, (b) the patch fails the detlab analysis, or (c) the code cave analysis is greater than 40%.

If the patch fails the heuristic function(s) or the external third-party service, at step 206, the patch evaluation system moves the patch to a quarantine storage system. The quarantine storage system can generate an alert to initiate manual review when a failed path is detected. For example, when a patch is moved into the quarantine storage system, a Rapid7 alert is automatically triggered to initiate manual review.

At step 208, the patch evaluation system performs a manual review of the patch. The manual review process can include checking the file in a detlab, a manual binary analysis, and further heuristics. In some implementations, the manual review process may involve a comprehensive examination of the patch by security experts. This review may include a detailed analysis of the patch's code structure, functionality, and potential impact on the target system. The reviewers may use specialized tools and techniques to dissect the patch, looking for any signs of malicious code, unintended side effects, or vulnerabilities that automated scans might have missed. Additionally, the manual review process may involve cross-referencing the patch with known security databases and threat intelligence sources to identify any potential connections to existing malware or attack patterns.

The manual review may also consider the context of the patch, including its source, intended purpose, and the criticality of the system it is meant to update. Reviewers may simulate the patch's installation in a controlled environment to observe its behavior and interactions with the system. In some cases, the review process may involve reaching out to the patch provider for additional information or clarification. The results of this manual review may be documented in detail, including any findings, recommendations, and a final determination of the patch's safety. The manual review process may serve as an additional layer of security, helping to catch potential threats that automated systems may not detect.

At step 210, the system determines if the patch is safe based on the manual review process.

If manual review determines the patch unsafe, at step 212, the system generates an alert to prevent the patch from being installed. In some embodiments, an unsafe patch is terminated, and a report is sent to the provider of the patch.

If the manual review process determines the patch is safe, at step 214, the patch is manually moved into the production environment storage system. For example, if the malicious alert for the patch is determined to be a false positive, a security orchestration, automation, and response (SOAR) workflow will be initiated to move the patch to the production environment storage system. Once a patch is moved into the production environment storage system, a user can install the patch.

If the patch does not fail the heuristic function(s) or the external third-party service (at step 204), the patch evaluation system places the patch into a success queue and the associated file key is used to identify the file in the storage system. The approved patch is moved into the production environment storage system and is available for installation.

At step 216, the patch evaluation system displays the patch score to users. For example, when a patch is moved into the production environment storage system, the patch safe score is exposed to users through a platform console. A User can utilize the platform console to prevent patches from being installed based on the patch safe score, or any of the individual heuristic functions that are used to calculate the patch safe score.

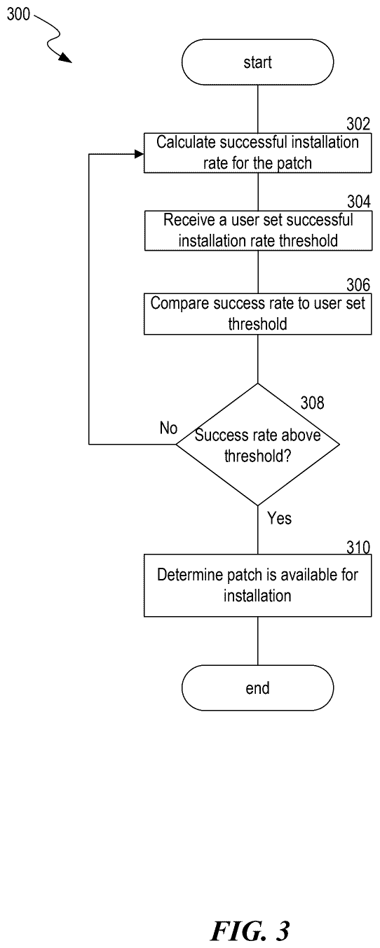

FIG. 3 is a flow diagram illustrating a process used in some implementations for calculating a successful installation rate of a patch, in accordance with one or more embodiments of the present technology. In some implementations, process 300 is triggered by a user activating a patch evaluation application, powering on a device, the user accessing a patch provider database via a website portal, a machine or device receiving a patch from a manufacturer, or the user downloading an application on a device to access the patch evaluation system. In various implementations, some or all of process 300 is performed locally on the user device or performed by cloud-based device(s) that can provide/support the patch evaluation system.

At step 302, the patch evaluation system calculates the successful installation rate for the patch as users install the patch. The successful installation is based on the characteristics of the environment in which the patch is installed. Internal scripts that install a patch can report whether the installation was successful, or not. The patch evaluation system can aggregate the results across all attempts to install that particular patch in a customer base. Once a predetermined number of patches are applied (successfully or not), the patch evaluation system determines the patch to have statistical significance, and the installation success rate is provided to the platform console.

At step 304, the patch evaluation system receives a user set successful installation rate threshold. For example, a user sets a “successful installation percentage” threshold such that patches below the threshold are determined unavailable for installation. The threshold(s) can be combined with other data. In a first example, a user sets a lower successful installation threshold if a patch is remediating a “critical” vulnerability. In a second example, a user sets a higher successful installation threshold if a patch is remediating a “medium” vulnerability.

At step 306, the patch evaluation system compares the successful installation rate for the patch to the user set threshold. At step 308, the patch evaluation system determines if the successful installation rate is equal to or above the user set threshold.

If the successful installation rate is equal to or above the user set threshold, at step 310, the system patch evaluation determines the patch is available for installation. The patch installation availability can be dynamic, such that a patch becomes available if the successful installation percentage increases equal to or above the threshold, or the patch is removed from availability, when the successful installation percentage falls below the threshold over time.

If the successful installation rate is not equal to or above the user set threshold, the patch evaluation system determines the patch is unavailable for installation. The patch evaluation system can re-calculate (at step 302) the successful installation rate for the patch as more users install the patch.

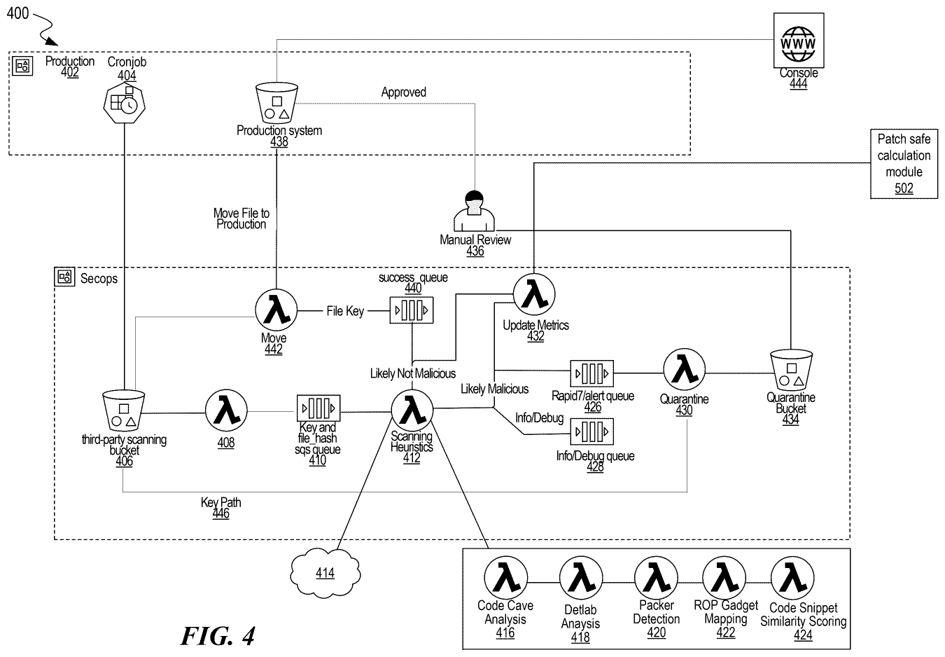

FIG. 4 illustrates an example diagram 400 for evaluating a patch, in accordance with one or more embodiments of the present technology. The patch evaluation process begins with production module 402 collecting third party binaries and/or applications from a third-party server (e.g., cronjob 404). During a cron task, the third-party binaries and/or applications are copied into the third-party scanning bucket 406 (e.g., a S3 third-party scanning bucket). Upon entering the third-party scanning bucket 406, the lambda 408 is triggered. Lambda 408 identifies the S3 file key and calculates the file hash of the application, and subsequently puts the file hash and S3 key into the associated SQS queue 410.

Scanning heuristics lambda 412 takes the file hash and S3 key from the SQS queue 410 sends both to an external third-party service 414 (e.g., VirusTotal). The scanning heuristics lambda 412 is comprised of multiple lambdas, such as a code cave analysis lambda 416, detlab analysis lambda 418, packer detection lambda 420, ROP gadget mapping lambda 422, and code snippet similarity scoring lambda 424. If at any point any heuristic fails, the patch is into the quarantine pathway.

The scanning heuristics lambda 412 performs a set of additional code analysis internally. The set of additional code analysis includes code cave analysis via code cave analysis lambda 416, detlab analysis via detlab analysis lambda 418, packer detection via packer detection lambda 420, ROP gadget mapping via ROP gadget mapping lambda 422, and code snippet similarity scoring via code snippet similarity scoring lambda 424. Portions of the detlab analysis can be automated. In some embodiments, the code snippet similarity scoring lambda 424 utilizes a customized machine learning model(s) generate the scoring. The results of the additional code analysis are used to calculate a patch safe score for the patch. If the patch fails the third-party scan, the analysis by scanning heuristics lambda 412, or any of the additional code analysis by lambdas 416-424, the patch is moved to a quarantine storage system. The third-party scanning bucket 406 moves the suspicious/failed patch to the quarantine lambda 430 via key path 446.

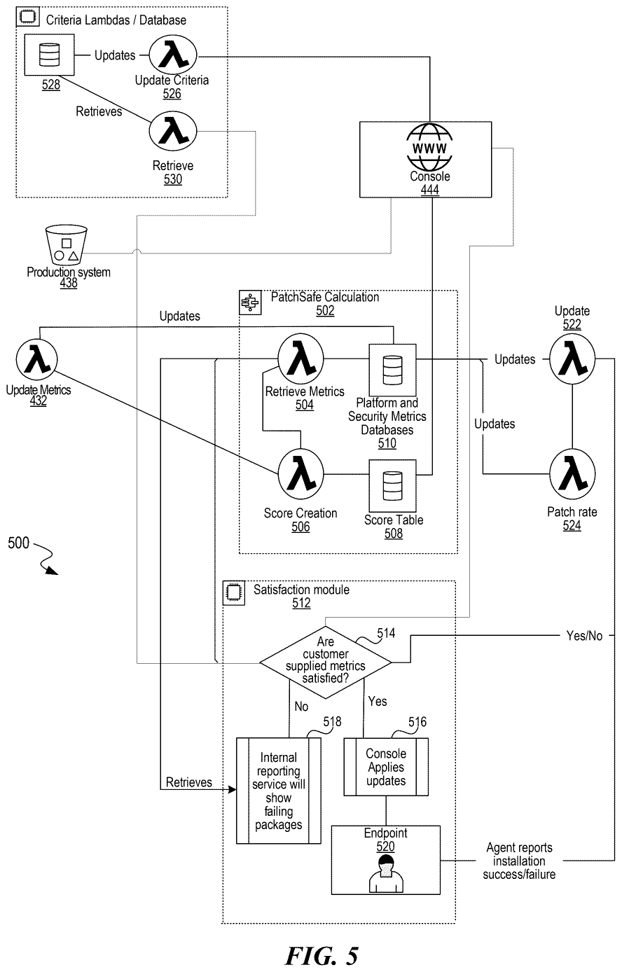

The quarantine storage system includes a rapid 7 alert queue 426, info/debug queue 428, quarantine lambda 430, update metrics lambda 432, quarantine bucket 434, and manual review module 436. For example, a patch determined to be “likely malicious” is moved to the quarantine bucket 434 via rapid7 alert queue 426 and quarantine lambda 430. The quarantine lambda 430 quarantines the file in the quarantine bucket 434 based on the key. The update metrics lambda 432 sends the heuristic results to patch safe calculation module 502 and receives updated metrics from the patch safe calculation module 502 (further described in FIG. 5).

Patches remain in the quarantine bucket 434 until a manual review process occurs by manual review module 436 (e.g., by a member of a security team). The manual review process will include checking the file in a detlab, manual binary analysis, and further heuristics. If the manual review process determines that the patch is safe, then the patch is manually moved into the production environment storage system 438. For example, if the malicious alert for the patch is determined to be a false positive, a SOAR workflow will be initiated to move the application to the production environment storage system 438.

If the patch does not fail the analysis by scanning heuristics lambda 412 or any of the additional code analysis by lambdas 416-424, the patch is placed into the success queue 440 and the associated file key is used to identify the file in the storage system. The patch and file key are moved via move lambda 442 into the production environment storage system 438.

If the patch does not fail the third-party scan the patch and file key is moved from the third-party scanning bucket 406 to the production environment storage system 438 via move lambda 442. Once in the production environment storage system 438, users can install the patch via a platform console 444.

FIG. 5 illustrates an example diagram 500 for calculating a patch safe score, in accordance with one or more embodiments of the present technology. The patch safe calculation module 502 uses the results of the code analysis (e.g., performed by the scanning heuristics lambda 412, the code cave analysis lambda 416, the detlab analysis lambda 418, the packer detection lambda 420, the ROP gadget mapping lambda 422, and/or the code snippet similarity scoring lambda 424 of FIG. 4) to calculate a patch safe score.

The platform and security metrics databases 510 receive the additional code analysis results from the update metrics lambda 432. The retrieve metrics lambda 504 retrieves and sends the results to the score creation lambda 506. In some embodiments, the score creation lambda 506 receives the results directly from the update metrics lambda 432. The score creation lambda 506 creates the patch safe score and stores the patch safe score in the score table 508. The platform console 444 retrieves the patch safe score from the score table 508 and the metrics from the platform and security metrics databases 510.

When a patch is moved into the production environment storage system 438, the patch safe score is exposed to users through the platform console 444. Users can utilize the platform console 444 to prevent patches from being installed based on the patch safe score, or any of the individual heuristics that are used to calculate the patch safe score.

As a user reviews the patch safe score from platform console 444, the satisfaction module 512 determines if the user supplied metrics are satisfied (at 514). If the user supplied metrics are not satisfied, the satisfaction module 512 performs an internal reporting service to show failing packages (at 518). The retrieve metrics lambda 504 retrieves the unsatisfactory metrics and failing packages information.

If the user supplied metrics are satisfied, platform console 444 applies updates (at 516) to an endpoint 520. The satisfaction module 512 determines the installation success/failure (e.g., an agent reports installation success/failure of a patch). For example, as users apply the patch, satisfaction module 512 calculates the successful installation rate for the patch (which may be broken out by characteristics of the environment in which the patch is installed). Once a predetermined number of patches are applied (successfully or not), the patch is deemed to have statistical significance, and the installation success rate is provided to the platform console 444. The update lambda 522 collects the installation success/failure reports and stores the installation patch rates in the platform and security metrics databases 510. The patch rate lambda 524 calculates patch rates and stores the installation patch rates in the platform and security metrics databases 510.

The criteria lambdas/database 528 receives, from a user, a “successful installation percentage” threshold such that patches with patch safe scores below the threshold are not deemed available for installation. The threshold is dynamic such that a patch becomes available (or is removed from availability) if the successful installation percentage increases equal to or above the threshold (or falls below the threshold) over time. The update criteria lambda 526 receives the installation success rate from the platform console 444 and updates the user supplied third-party criteria in database 528. The retrieve lambda 530 retrieves user supplied metrics and checks if the metrics meet the required threshold.

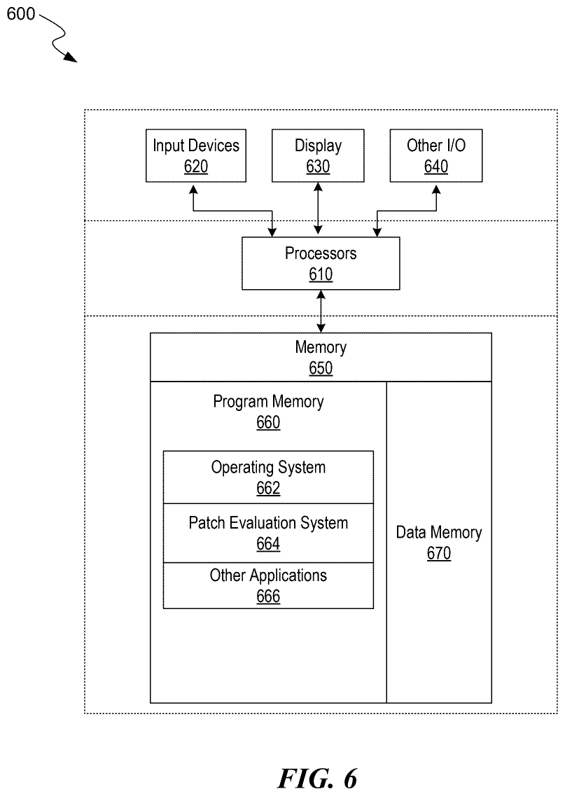

FIG. 6 is a block diagram illustrating an overview of devices on which some implementations of the disclosed technology can operate. The devices can comprise hardware components of a device 600 that manage entitlements within a real-time telemetry system. Device 600 can include one or more input devices 620 that provide input to the processor(s) 610 (e.g., CPU(s), GPU(s), HPU(s), etc.), notifying it of actions. The actions can be mediated by a hardware controller that interprets the signals received from the input device and communicates the information to the processors 610 using a communication protocol. Input devices 620 include, for example, a mouse, a keyboard, a touchscreen, an infrared sensor, a touchpad, a wearable input device, a camera-or image-based input device, a microphone, or other user input devices.

Processors 610 can be a single processing unit or multiple processing units in a device or distributed across multiple devices. Processors 610 can be coupled to other hardware devices, for example, with the use of a bus, such as a PCI bus or SCSI bus. The processors 610 can communicate with a hardware controller for devices, such as for a display 630. Display 630 can be used to display text and graphics. In some implementations, display 630 provides graphical and textual visual feedback to a user. In some implementations, display 630 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 640 can also be coupled to the processor, such as a network card, video card, audio card, USB, firewire or other external device, camera, printer, speakers, CD-ROM drive, DVD drive, disk drive, or Blu-Ray device.

In some implementations, the device 600 also includes a communication device capable of communicating wirelessly or wire-based with a network node. The communication device can communicate with another device or a server through a network using, for example, TCP/IP protocols. Device 600 can utilize the communication device to distribute operations across multiple network devices.

The processors 610 can have access to a memory 650 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 650 can include program memory 660 that stores programs and software, such as an operating system 662, patch evaluation system 664, and other application programs 666. Memory 650 can also include data memory 670, storing as hash data, malware data, patch safe score data, quarantine data, threshold data, heuristic function data, third-party scanning data, installation data, manual review data, key data, or any criteria associated with a patch, configuration data, settings, user options or preferences, etc., which can be provided to the program memory 660 or any element of the device 600.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

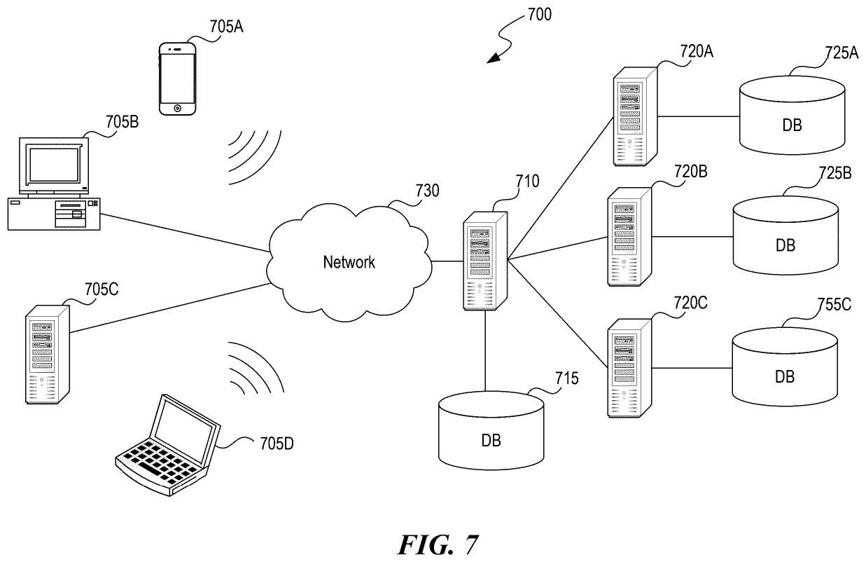

FIG. 7 is a block diagram illustrating an overview of an environment 700 in which some implementations of the disclosed technology can operate. Environment 700 can include one or more client computing devices 705A-D, examples of which can include device 600. Client computing devices 705 can operate in a networked environment using logical connections through network 730 to one or more remote computers, such as a server computing device 710.

In some implementations, server 710 can be an edge server which receives client requests and coordinates fulfillment of those requests through other servers, such as servers 720A-C. Server computing devices 710 and 720 can comprise computing systems, such as device 600. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server/client devices. Server 710 can connect to a database 715. Servers 720A-C can each connect to a corresponding database 725A-C. As discussed above, each server 720 can correspond to a group of servers, and each of these servers can share a database or can have their own database. Databases 715 and 725 can warehouse (e.g., store) information such as implement data, machine data, sensor data, device data, notification data, hash data, malware data, patch safe score data, quarantine data, threshold data, heuristic function data, third-party scanning data, installation data, manual review data, key data, or any criteria associated with a patch. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. Network 730 may be the Internet or some other public or private network. Client computing devices 705 can be connected to network 730 through a network interface, such as by wired or wireless communication. While the connections between server 710 and servers 720 are shown as separate connections, these connections can be any kind of local, wide area, wired, or wireless network, including network 730 or a separate public or private network.

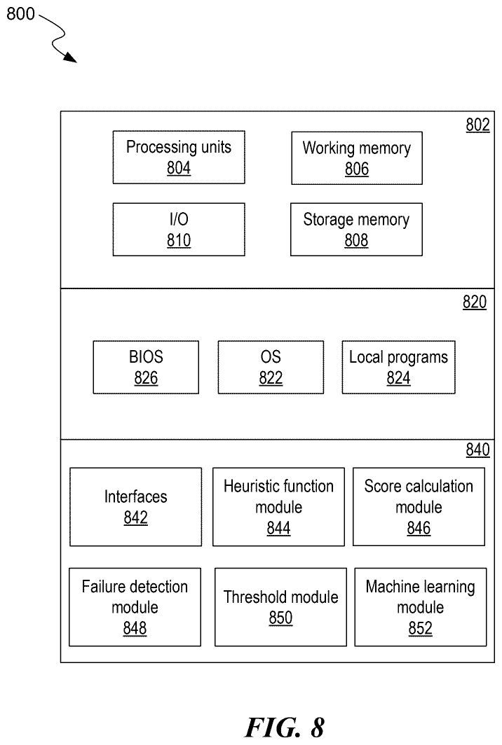

FIG. 8 is a block diagram illustrating components 800 which, in some implementations, can be used in a system employing the disclosed technology. The components 800 include hardware 802, general software 820, and specialized components 840. As discussed above, a system implementing the disclosed technology can use various hardware including processing units 804 (e.g. CPUs, GPUs, APUs, etc.), working memory 806, storage memory 808 (local storage or as an interface to remote storage, such as storage 715 or 725), and input and output devices 810. In various implementations, storage memory 808 can be one or more of: local devices, interfaces to remote storage devices, or combinations thereof. For example, storage memory 808 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 715 or storage provided through another server 720). Components 600 can be implemented in a client computing device such as client computing devices 705 or on a server computing device, such as server computing device 710 or 720.

General software 820 can include various applications including an operating system 822, local programs 824, and a basic input output system (BIOS) 826. Specialized components 840 can be subcomponents of a general software application 820, such as local programs 824. Specialized components 840 can include heuristic function module 844, score calculation module 846, failure detection module 848, threshold module 850, machine learning module 852, and components which can be used for providing user interfaces, transferring data, and controlling the specialized components, such as interfaces 842. In some implementations, components 800 can be in a computing system that is distributed across multiple computing devices or can be an interface to a server-based application executing one or more of specialized components 840. Although depicted as separate components, specialized components 840 may be logical or other nonphysical differentiations of functions and/or may be submodules or code-blocks of one or more applications.

In some implementations, heuristic function module 844 is configured to execute various analysis techniques on patches to determine patch safety. In some implementations, score calculation module 846 is configured to compute a safety score for patches based on the heuristic analysis results. In some implementations, failure detection module 848 is configured to monitor and identify patch installation failures. In some implementations, threshold module 850 is configured to manage user-defined thresholds for patch safety and installation success rates. In some implementations, machine learning module 852 is configured to improve the system's ability to detect unsafe patches or predict installation success over time. The specialized components 840 work together to evaluate incoming patches, calculate safety scores, detect failures, apply thresholds, and potentially use machine learning to enhance the overall patch management process. This system architecture allows for automated and intelligent handling of third-party software patches, improving security and reliability in software update processes.

Those skilled in the art will appreciate that the components illustrated in FIGS. 6-8 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method comprising:
receiving a patch for application software from a third-party operation system;
calculating a file hash for the patch;
executing at least one heuristic function on the file hash to determine if the patch is safe for installation;
in response to determining the patch is safe for installation, moving the patch into a production environment; and
in response to determining the patch is not safe for installation,
moving the patch into a quarantine system, and
receiving data confirming completion at least one manual review process of the patch.

2. The method of claim 1, further comprising:
calculating a patch safe score for the patch based on results of executing the at least one heuristic function; and
in response to the patch being moved into the production environment,
displaying the patch safe score via a platform console, and
generating a notification that the patch is approved for installation via the platform console.

3. The method of claim 1, further comprising:
sending the file hash to an external third-party service for malware detection;
receiving a notification that the external third-party service detected malware in the patch based on the file hash; and
in response to the external third-party service detecting malware in the patch, moving the patch into the quarantine system.

4. The method of claim 1, further comprising:
calculating a patch safe score for the patch based on results of executing the at least one heuristic function; and
preventing the patch from being installed based on the patch safe score.

5. The method of claim 1, further comprising:
receiving an installation success rate threshold from a user device;
determining a current installation success rate for the patch;
in response to the current installation success rate being below the installation success rate threshold, determining the patch is available for installation on the user device; and
in response to the current installation success rate not being below the installation success rate threshold, determining the patch is unavailable for installation on the user device.

6. The method of claim 1, further comprising:
in response to determining the patch is not safe for installation, generating an alert that triggers the at least one manual review process of the patch.

7. The method of claim 1, wherein the at least one heuristic function performs a code cave analysis, a detlab analysis, a packer detection, return-oriented programming gadget mapping, or code snippet similarity scoring.

8. A system comprising:
one or more processors; and
one or more memories storing instructions that, when executed by the one or more processors, cause the system to perform a process comprising:
receiving a patch for application software from a third-party operation system;
calculating a file hash for the patch;
executing at least one heuristic function on the file hash to determine if the patch is safe for installation;
in response to determining the patch is safe for installation, moving the patch into a production environment; and
in response to determining the patch is not safe for installation,
moving the patch into a quarantine system, and
receiving data confirming completion at least one manual review process of the patch.

9. The system of claim 8, wherein the process further comprises:
calculating a patch safe score for the patch based on results of executing the at least one heuristic function; and
in response to the patch being moved into the production environment,
displaying the patch safe score via a platform console, and
generating a notification that the patch is approved for installation via the platform console.

10. The system of claim 8, wherein the process further comprises:
sending the file hash to an external third-party service for malware detection;
receiving a notification that the external third-party service detected malware in the patch based on the file hash; and
in response to the external third-party service detecting malware in the patch, moving the patch into the quarantine system.

11. The system of claim 8, wherein the process further comprises:
calculating a patch safe score for the patch based on results of executing the at least one heuristic function; and
preventing the patch from being installed based on the patch safe score.

12. The system of claim 8, wherein the process further comprises:
receiving an installation success rate threshold from a user device;
determining a current installation success rate for the patch;
in response to the current installation success rate being below the installation success rate threshold, determining the patch is available for installation on the user device; and
in response to the current installation success rate not being below the installation success rate threshold, determining the patch is unavailable for installation on the user device.

13. The system of claim 8, wherein the process further comprises:
in response to determining the patch is not safe for installation, generating an alert that triggers the at least one manual review process of the patch.

14. The system of claim 8, wherein the at least one heuristic function performs a code cave analysis, a detlab analysis, a packer detection, return-oriented programming gadget mapping, or code snippet similarity scoring.

15. A non-transitory computer-readable medium storing instructions that, when executed by a computing system, cause the computing system to perform operations comprising:
receiving a patch for application software from a third-party operation system;
calculating a file hash for the patch;
executing at least one heuristic function on the file hash to determine if the patch is safe for installation;
in response to determining the patch is safe for installation, moving the patch into a production environment; and
in response to determining the patch is not safe for installation,
moving the patch into a quarantine system, and
receiving data confirming completion at least one manual review process of the patch.

16. The non-transitory computer-readable medium of claim 15, wherein the operations further comprise:
calculating a patch safe score for the patch based on results of executing the at least one heuristic function; and
in response to the patch being moved into the production environment,
displaying the patch safe score via a platform console, and
generating a notification that the patch is approved for installation via the platform console.

17. The non-transitory computer-readable medium of claim 15, wherein the operations further comprise:
sending the file hash to an external third-party service for malware detection;
receiving a notification that the external third-party service detected malware in the patch based on the file hash; and
in response to the external third-party service detecting malware in the patch, moving the patch into the quarantine system.

18. The non-transitory computer-readable medium of claim 15, wherein the operations further comprise:
calculating a patch safe score for the patch based on results of executing the at least one heuristic function; and
preventing the patch from being installed based on the patch safe score.

19. The non-transitory computer-readable medium of claim 15, wherein the operations further comprise:
receiving an installation success rate threshold from a user device;
determining a current installation success rate for the patch;
in response to the current installation success rate being below the installation success rate threshold, determining the patch is available for installation on the user device; and
in response to the current installation success rate not being below the installation success rate threshold, determining the patch is unavailable for installation on the user device.

20. The non-transitory computer-readable medium of claim 15, wherein the operations further comprise:
in response to determining the patch is not safe for installation, generating an alert that triggers the at least one manual review process of the patch,
wherein the at least one heuristic function performs a code cave analysis, a detlab analysis, a packer detection, return-oriented programming gadget mapping, or code snippet similarity scoring.
